(19) United States
(12) Patent Application Publication
(10) Pub. No.: US 2011/0020770 A1
(43) Pub. Date: Jan. 27, 2011

(54) DENTAL SPLINTS AND METHOD FOR USING THE SAME

(76) Inventor: Prasad Adusumilli, PARSIPPANY, NJ (US)

Correspondence Address: GlaxoSmithKline;GLOBAL PATENTS -US, UW2220, P. O. BOX 1539, KING OF PRUSSIA, PA, 19406-0939, US

(21) Appl. No.: 12/918,338

(22) PCT Filed: Feb. 20, 2009
(86) PCT No.: PCT/US09/34670

§ 371 Date: Oct. 1, 2010

Related U.S. Application Data
(60) Provisional application No. 61/030,786, filed on Feb. 22, 2008.

(51) Int. Cl. A61C 9/00; A61C 19/00

(52) U.S. Cl. 433/214; 433/215

(57) ABSTRACT

This disclosure relates to a device and method for reconditioning the muscles and tissues, in particular, the gums, of an edentulous patient.

### BACKGROUND OF THE DISCLOSURE

1. Field of the Disclosure

The present disclosure relates to devices and methods for conditioning the muscles and tissues, in particular, the gums, of an edentulous patient. More particularly, the present disclosure relates to pre-molded occlusal splints that can be placed on a patient's denture.

2. Description of the Related Art

Full or partial dentures are intended to be worn in the mouth to replace missing teeth. Current processes for manufacturing dentures involve multiple steps, which include multiple examinations of the patient and taking multiple measurements of the patient relating to their facial and oral structure.

In determining the aesthetic “look and feel” of the end-result denture, the dental practitioner relies on a number of facial and intraoral measurements. Before a denture is made, a dental practitioner may determine the need for conditioning the patient's muscles and tissues, which can atrophy or deteriorate after long periods of the patient not having any teeth, or having a denture that no longer provides the proper support for the patient. This condition is caused at least in part by resorption of the bone, which leads to receding gums. Conditioning strengthens the tissue and readjusts the patient's facial features, which may have become distorted by missing teeth or faulty existing dentures. In addition, the dental practitioner adjusts the vertical dimension of the dentures, which is a measurement of the ideal distance between the upper and lower teeth. The practitioner creates enough freeway space between the two, so that when a patient is using his dentures, the denture teeth do not contact one another and the mandible is at resting position without creating any stress and strain in the patient's jaw.

Accordingly, there is a need for a device and method for making this process as efficient and cost-effective as possible.

### SUMMARY OF THE DISCLOSURE

The present disclosure provides a pre-fabricated dental occlusal splint.

The present disclosure also provides a method for using a prefabricated dental occlusal splint for conditioning muscles and tissues of an edentulous patient.

The present disclosure also provides a method for using a pre-fabricated dental occlusal splint for measuring the vertical dimension of an edentulous patient.

Thus, in one embodiment, the present disclosure provides a method for affixing an occlusal splint to the denture of a patient. The method comprises the steps of measuring the proper vertical dimension of the patient, fabricating a plurality of the occlusal splints, determining the proper size and shape of the occlusal splint to be affixed to the denture, and affixing the occlusal splint to the denture. The method can further comprise applying a moldable material to a surface of the occlusal splint that is on an opposite side of the occlusal splint from the denture, having the patient bite down to produce an impression of the occlusal surface of the opposing teeth in the moldable material, and curing the moldable material.

### BRIEF DESCRIPTION OF THE DRAWINGS

FIG. 1 shows a plurality of the occlusal splints of the present disclosure, and several perspective views;

FIG. 2 shows the splints of FIG. 1 affixed to a denture;

FIG. 3 shows a cross-sectional view of the denture of FIG. 2 along sectional line A-A, in several different sizes;

FIG. 4 shows an exploded view of a denture having existing teeth formed thereon, and with the splint of the present disclosure; and

FIG. 5 shows a dispenser for dispensing sheets of material used for providing a proper occlusal contact on the splints of the present disclosure.

### DETAILED DESCRIPTION OF THE DISCLOSURE

The term “denture(s)” is used herein to refer to dentures or partial dentures, artificial teeth, removable orthodontic bridges and denture plates, both upper and lower types, orthodontic retainers and appliances, protective mouthguards, and nightguards to prevent bruxism and/or temporomandibular joint (TMJ) disorder.

The term “vertical dimension” is used herein to refer to the vertical height of an upper and lower denture when the teeth are in rest with required freeway space. This distance is adjusted such that there is sufficient interocclusal distance or freeway space. Freeway space is defined as the distance between the occluding surfaces of the upper and lower teeth when the mandible is in rest position.

In the present disclosure, occlusal splints of various sizes and shapes can be prefabricated using an injection molding process. The patient comes in for a fitting, usually with their existing denture. Using an appropriately sized and shaped pre-made occlusal splint, the dental practitioner simply places the splint on the denture and secures it in place with a suitable dental adhesive. After establishing the correct vertical dimension and securing the splint in place with an appropriate adhesive, a small amount of moldable material can be added to the top surface of the splint. The patient then bites on the denture, and establishes the proper occlusal contacts between me upper and lower teeth directly on the splint. The patient then wears the denture having the splint for the desired amount of time to complete the conditioning of the patient's muscle and tissues, while a new denture is being fabricated. After the conditioning is complete, the denture with the splints is removed, and the new denture is delivered to the patient for use.

Thus, the present disclosure provides a much easier and simpler method than what is currently available. In some current methods, a gothic arch tracing device is used. A gothic arch training device uses a weighted or spring-loaded needle that is attached to one jaw, and a coated plate attached to the other jaw. Movement of the patient's mandible causes the needle to trace a pattern on the horizontally placed coated plate. When the point of the needle is at the apex of the tracing, the mandible is said to be in the horizontal position of centric relation, a position which is needed in order to determine the proper vertical dimension. Splints are then made by mixing polymethyl methacrylate (PMMA) polymer with PMMA monomer in a recommended ratio from the manufacturer, into the consistency of a dough. This dough is then rolled into a cylinder and attached to the lower denture and pressed to form a long thick mass on the denture with a flat upper surface facing away from the denture palette. The patient bites down on this PMMA flat surface to establish the proper occlusal contact at the proper vertical dimension. The denture with the soft splint in place is then cured in a light chamber, and trimmed and polished.

This process is undesirable for several reasons. First, the splint dough destroys the denture, since it bonds to the denture. Consequently, a duplicate denture has to be created for the conditioning process, since the patient will often determine that they do not wish to complete the conditioning process, and wish to keep their original dentures. The need to create a duplicate denture obviously adds significantly to the cost and labor involved. Additionally, the monomers that are mixed with the PMMA to form the splint paste are harmful. The monomers of polymers can be absorbed into the human body and cause unwanted side effects. The devices and methods of the present disclosure avoid these problems, because the patient's denture is not destroyed after the reconditioning process, and the monomer is not needed.

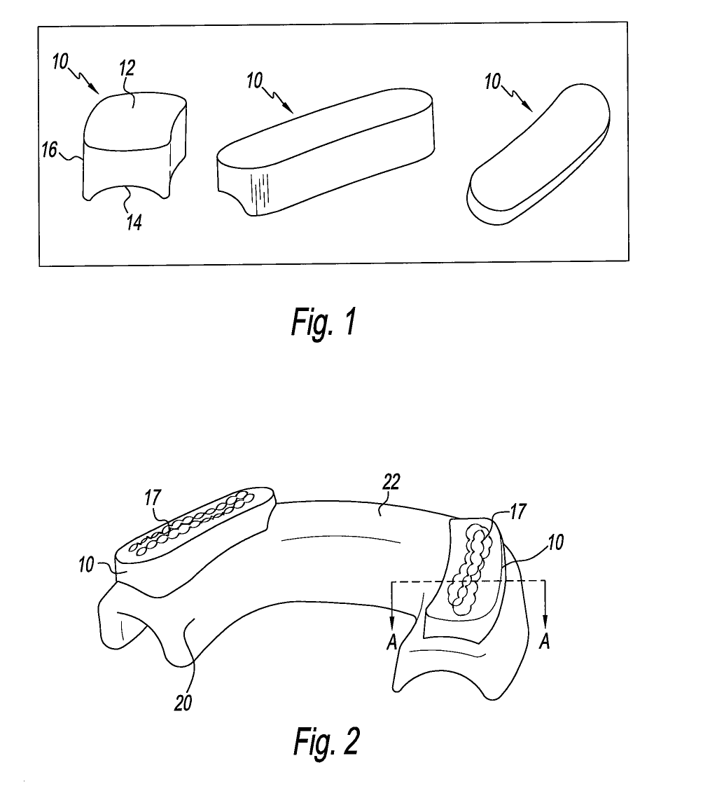

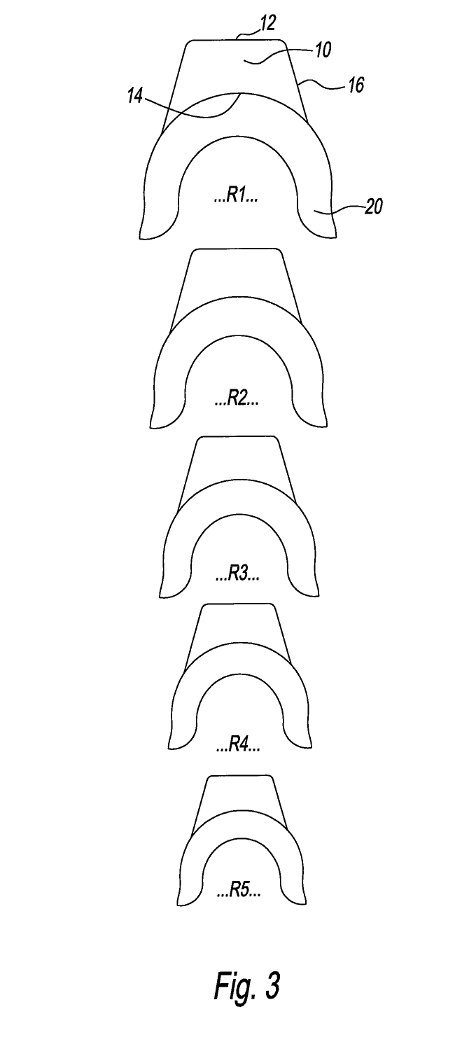

Referring to the drawings, and in particular FIGS. 1-4, pre-formed occlusal splints generally represented by reference numeral 10 of the present disclosure are shown. Splints 10 can be made from any material that can be formed or injection molded, such as but not limited to polyethylene, nylon, PMMA, and acrylonitrile butadiene styrene (ABS), and any combinations thereof. Splints 10 can have a top surface 12, and a curved bottom surface 14, which can substantially conform to a top surface 22 of a denture 20. As shown in FIG. 3, dentures 20 can have varying radii (e.g. R1, R2, R3, etc.), and Splints 10 can correspondingly have a number of radii of curvature of bottom surface 14. Splints 10 can also have varying shapes and heights. When a patient is being fitted for splint 10, the technician performing the procedure can determine which size of splint 10 best fits the patient's denture 20, and which size provides the desired vertical dimension. It may take several iterations to determine the proper size of splint 10 to use. Alternatively, an instrument, such as a pair of calipers, can be used to measure the width of the denture 20 and then select a splint 10 with the corresponding inner radius and the desired height.

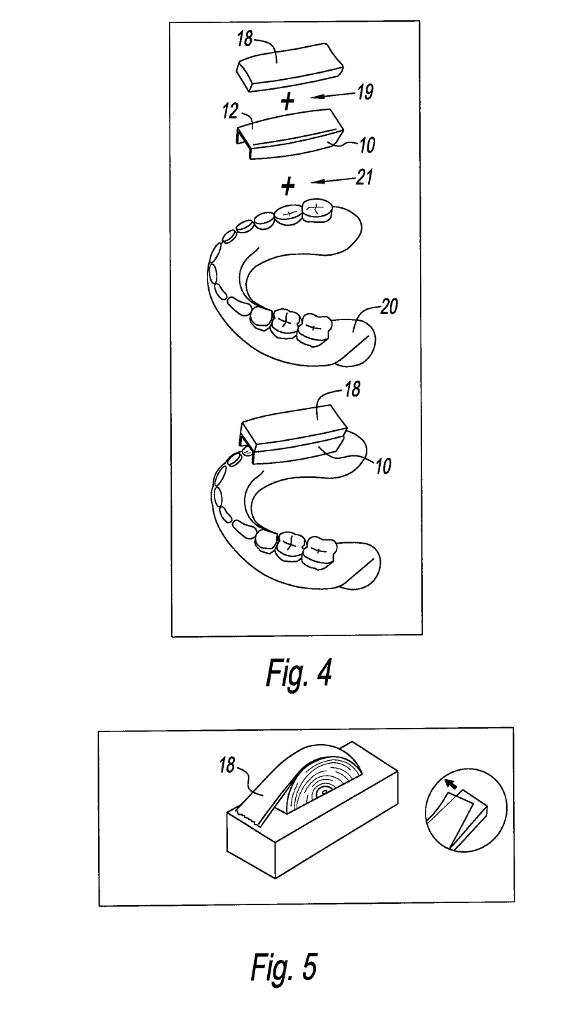

FIGS. 2 and 3 show a splint 10 that is affixed to a denture 20 without teeth, for ease of illustration. Typically, however, splint 10 will be affixed to a denture 20 with teeth already disposed thereon, as shown in FIG. 4. In either case, bottom surface 14 of splint 10 should substantially conform to the top surface 22 of denture 20, whether top surface 22 has teeth disposed on it or not.

Alternatively, the process of installing splints 10 can also be conducted after installing a gothic arch tracing device and holding the patient at the proper vertical dimension. However, as discussed above, since splints 10 of various sizes will be available in the method of the present disclosure, selecting splints 10 with the desired sizes would reduce or eliminate the need to install the tracers and significantly reduce the time and labor required in the process.

Splint 10 can then be applied to the denture 20 using an appropriate dental adhesive 21, such as a cyanoacrylate based adhesive, PMMA based cold cure or light cure acrylic adhesives, glass ionomer, polycarboxylate or resin based cements, or any combinations thereof. The adhesive can be applied along or under a side 16 or both sides 16 of splint 10 that is adjacent to top surface 12, so that it will be easier to remove at a later time. Again, this process is advantageous over those currently available, since splint 10 does not destroy denture 20 and can be removed at a later date, if desired.

After determining the size of splint 10 that will provide the proper vertical dimension for the patient, and securing it in place on denture 20, a small amount of moldable material 17 is applied to the top surface 12 of splint 10. The molten material can be a molten plastic, such as polyethylene, polypropylene, acrylonitrile butadiene styrene (ABS), or PMMA light cure resin, or can also be a silicone material, and any combinations thereof. The patient can then bite down on the moldable material 17, and establish the proper occlusal contact. Splint 10, including the moldable material 17 that now includes the impression made by the patient's upper teeth, is cured. The curing can take place in either a light chamber or by other methods such as with heat. Forming a molded occlusal contact is an important step, since a proper occlusal contact between the denture 20 and the patient's other teeth, whether they be natural or synthetic, is needed for proper function.

As shown in FIGS. 4 and 5, the moldable material can also be in the form of a sheet 18. Sheet 18 can include any of the materials disclosed above for the layer of moldable material 17, and can be applied to top surface 12 of splint 10 with or without the use of an adhesive 19. Adhesive 19 can be in either molten or strip form. In some embodiments, sheet 18 may be preferred, since sheets of this nature are more readily available and do not need to be formulated. It may also be easier to apply sheets 18 to splint 10. In addition, sheet 18 will often adhere to splint 10 itself, without the need for adhesive 19.

After this process is complete, the patient wears the denture 20 having the splint 10 for a period of time sufficient to condition the patient's muscle and tissues, and restore the desired facial features. The new denture is separately being fabricated during this time. Splint 10 can then be removed, if desired, and the old denture and the new denture are delivered to the patient. Because splint 10 has conditioned the patient's muscles and tissues at the correct vertical dimension, the new denture fabricated to work with the proper vertical dimension will fit and function well, without causing any discomfort to the patient.

While the present disclosure discusses features in the singular case, it is understood that singular terms can also mean their plural equivalents where applicable. In addition, the present disclosure has been described with particular reference to certain embodiments. It should be understood that the foregoing descriptions and examples are only illustrative of the invention. Various alternatives and modifications thereof can be devised by those skilled in the art without departing from the spirit and scope of the present disclosure. Accordingly, the present disclosure is intended to embrace all such alternatives, modifications, and variations that fall within the scope of the appended claims.

What is claimed is:

1. A method for affixing an occlusal splint to the denture of a patient, comprising:
measuring the proper vertical dimension of the patient;
fabricating the occlusal splint;
determining the proper size of the occlusal splint to be affixed to the denture; and
affixing the occlusal splint to the denture.

2. The method of claim 1, further comprising:
applying a moldable material to a surface of the occlusal splint that is on the opposite side of the occlusal splint from the denture;
having the patient bite down to produce an impression of the occlusal surface of the opposing teeth in said moldable material; and
curing said moldable material.

3. The method of claim 2, further comprising forming an occlusal contact in said moldable material before said curing step.

4. The method of claim 2, wherein said moldable material is selected from the group consisting of a molten thermoplastic, polymethyl methacrylate light cure resin, silicone, and any combinations thereof.

5. The method of claim 4, wherein said molten thermoplastic is selected from the group consisting of polyethylene, polypropylene, acrylonitrile butadiene styrene, and any combinations thereof.

6. The method of claim 2, wherein said moldable material is a sheet that is affixed to a top surface of said denture.

7. The method of claim 2, wherein said moldable material is cured in either a light chamber or with heat.

8. The method of claim 1, wherein the occlusal splint is made from a material selected from the group consisting of polyethylene, nylon, polymethyl methacrylate, and acrylonitrile butadiene styrene, and any combinations thereof.

9. The method of claim 1, wherein the occlusal splint is injection molded.

10. The method of claim 1, wherein the occlusal splint is affixed to the denture with an adhesive.

11. The method of claim 10, wherein said adhesive is selected from the group consisting of cyanoacrylate based adhesives, polymethyl methacrylate based cold cure or light cure acrylic adhesives, glass ionomer, polycarboxylate or resin based cements, and any combinations thereof.

12. The method of claim 10, wherein said adhesive is applied to a side of said splint that is adjacent to said surface of the occlusal splint.

13. The method of claim 10, wherein said adhesive is applied to both sides of said splint that are adjacent to said surface of the occlusal splint.

14. The method of claim 1, wherein the occlusal splint has a bottom surface that substantially conforms to a top surface of the denture.

15. The method of claim 1, wherein said fabricating step comprises fabricating a plurality of occlusal splints.
